(19) United States
(12) Patent Application Publication
(10) Pub. No.: US 2009/0223762 A1
(43) Pub. Date: Sep. 10, 2009

(54) Shock Absorber

(75) Inventors: Akiyoshi Horikawa, Tokyo (JP); Yuta Ohmura, Tokyo (JP)

Correspondence Address: OLIFF & BERRIDGE, PLC, P.O. BOX 320850, ALEXANDRIA, VA, 22320-4850, US

(73) Assignee: Koganei Corporation, Tokyo (JP)

(21) Appl. No.: 11/884,304

(22) PCT Filed: Feb. 9, 2006
(86) PCT No.: PCT/JP06/02222

§ 371 Date: Aug. 14, 2007

(30) Foreign Application Priority Data
Mar. 14, 2005 (JP) 2005-070452

(51) Int. Cl. F16F 9/32

(52) U.S. Cl. 188/316

(57) ABSTRACT

A shock absorber with a possible minimum peak value of the impact acceleration during a collision. The shock absorber includes a tubular cylinder part with an opening at one end and the other end closed, a seal part configured to seal the internal space of this cylinder part at a part closer to this one end inside this cylinder part, fluid filled in the enclosed space formed by this seal part inside this cylinder part, a slidable piston part inside this enclosed space, and a rod part that slidably penetrates this seal part concentrically and is connected to this piston part at one end while projecting out to the other side. This cylinder part has a tapered inner surface inside this enclosed space, reducing its internal diameter from the one end to the other end, and the rate of this taper is within the range from 1/50 to 1/130.

### TECHNICAL FIELD OF THE INVENTION

The present invention relates to a shock absorber that uses the flow resistance of fluid flowing through a narrow gap to alleviate the impact of collision by absorbing the collision energy.

### BACKGROUND ART

Factory assembly lines or the like frequently entail a step for causing a carrying table to travel to and stop at a predefined position, so that a component or work(s) loaded on the carrying table may be brought to and stopped at such predefined position, and/or may undergo a pressing process or other required process thereat. In doing so, if the carrying table moves too fast, when the carrying table stops, the component etc. or the counterpart may get broken. It can also cause a loud noise, or depending on circumstances, can deform the carrying table.

Therefore, factory assembly lines or the like employ a shock absorber for stopping the carrying table to gradually reduce the traveling speed of the carrying table so that such inconvenience can be prevented.

FIG. 11 shows an example of such shock absorbers that are generally known to be used for the above described purpose.

In the same drawing, a tubular cylinder part is indicated by 10, and the cylinder part 10 has an opening at one end and is closed at the other end. A threaded hole for filling with silicon oil into an after-mentioned enclosed space 34 is concentrically formed at the other end of the cylinder part 10. A small screw 12 is screwed into the threaded hole via an O-ring 14. A thread is formed on the circumference of the cylinder part 10 and a couple of hex nuts 16 are screwed on it.

A piston 18 is concentrically inserted into the cylinder part 10 from one end. The piston 18 is composed of a rod part 20 and a piston part 22 which is configured at the end of the rod part 20. The rod part 20 is covered or surrounded by a sleeve 24 at the part proximal to the piston part 22, and the part distal to the piston part 22 projects from the one end of the cylinder part 10. The projecting end is covered with a protection cap (not indicated in the drawing).

Outside the sleeve 24, that is, between the sleeve 24 and the cylinder part 10, an accumulator 26 and an O-ring 28 are inserted. Inside the sleeve 24, that is, between the sleeve 24 and the rod part 20, a rod packing 30 is inserted. The ring-shaped gap between one end of the cylinder part 10 and the rod part 20 is enclosed with a ring-shaped plug 32.

Regarding the space inside the cylinder part 10, the area in front of the sleeve 24 is an enclosed space 34. The enclosed space 34 is filled with silicon oil. The internal space of the cylinder part 10 that is the space towards the other end from the piston part 22 accommodates a spring 36 along the inner surface of the cylinder part 10, biasing the piston part 22 to the one direction.

For example, the above described shock absorber can be installed so that the end of the rod part 20 projecting from the cylinder part can hit the carrying table on which a component is carried, at a point immediately before a predetermined position where that particular carrying table is to be stopped.

When the end of the rod part 20 hits the carrying table carrying a component, the rod part 20 is forced into the cylinder part 10, and the piston 18 is pushed to the other side into the cylinder part 10. Thus the silicon oil is pushed by the piston part 22 at the end of the piston 18, and the pushed silicon oil flows back through the gap between the piston part 22 and the cylinder part 10 while the flow resistance of the silicon oil absorbs the kinetic energy of the rod part 20, thus gradually reducing the pushing force of the rod part 20 so that the carrying table together with the component can be stopped at a desired position.

### Patent Document 1: Japanese Utility Model Unexamined Publication H4-19225 (Registration No.1952561)

### Patent Document 2: Japanese Utility Model Unexamined Publication S60-97432

### DISCLOSURE OF INVENTION

### Problem to be Solved by the Invention

In recent years, various products have been downsized and accordingly those components have become smaller and more sensitive. Therefore the impact acceleration during deceleration is preferable to be as small as possible and the development of a shock absorber with such a characteristic is desired.

It is an object of this invention to provide a shock absorber with a minimum peak value of the impact acceleration during a collision.

### Means of Solving the Problems

The shock absorber according to the present invention is characterized by a tubular cylinder part with an opening at one end and the other end closed; a seal part configured to seal the internal space of this cylinder part at a part closer to this one end inside this cylinder part; fluid filled in the enclosed space formed by this seal part inside this cylinder part; a piston part configured to be slidable inside this enclosed space; and a rod part that slidably penetrates this seal part concentrically and is connected to the piston part at one end while projecting out to the other side; wherein the shock absorber has a tapered inner surface of this cylinder part inside this enclosed space, reducing its internal diameter from the one end to the other end, and the rate of this taper is within the range from 1/50 to 1/130.

The reason why the rate of taper is set to be within the range from 1/50 to 1/130 is to lower the peak value of the impact acceleration during a collision. If the rate of taper exceeds 1/50, it results in an inconvenience of causing a large impact acceleration by the collision of the piston part 22 into the other end of the cylinder part 10 at the end of the impact absorption after the collision. If the rate of taper is less than 1/130, it results in an inconvenience of causing a large impact acceleration at the beginning of the impact absorption. If the rate of taper is between 1/50 and 1/130, it will not result in such inconveniences.

It is also preferable that the gap between the cylinder part and the piston part is within the range from 1/100 to 5/100 millimeter (mm) in proximity to the other end of the cylinder part. If the gap is less than 1/100 mm, it results in an inconvenience of prolonging the activation time. If the gap exceeds 5/100 mm, it results in an inconvenience of not completing the impact absorption at the end of the stroke. However if the gap is between 1/100 to 5/100 mm, it will lower the peak value of the impact acceleration during a collision, fulfilling its function as a shock absorber.

It is also preferable to use oil with a viscosity of 32 to 300 centi Stokes (cSt) for the fluid. If the fluid viscosity is less than 32 cSt, it results in an inconvenience of not gaining a sufficient impact absorbency. If the fluid viscosity exceeds 300 cSt, it results in inconveniences of exceeding an appropriate impact absorbency and prolonging the recovery time of the piston rod. However, if the fluid viscosity is between 32 to 300 cSt, it will lower the peak value of the impact acceleration during a collision, fulfilling its function as a shock absorber.

In addition, the enclosed space of the cylinder part may have the same range of the internal diameter as that of the side of the other end.

### Advantageous Effect of the Invention

The shock absorber of the present invention has the effect of minimizing the peak value of the impact acceleration during a collision, thereby making it possible to reduce an impact given to an object or work used, to a lowest possible degree.

### BRIEF DESCRIPTION OF THE DRAWINGS

FIG. 1 is an illustration of the shock absorber according to an embodiment of the present invention.

FIG. 2 is an outline illustration of the experimental device that was used in the collision experiment.

FIG. 3 is a graph to indicate the relationship between the stroke of the piston part and the impact acceleration when the rate of taper on the inner surface of the cylinder part is straight.

FIG. 4 is a graph to indicate the relationship between the stroke of the piston part and the impact acceleration when the rate of taper on the inner surface of the cylinder part is 1/130.

FIG. 5 is a graph to indicate the relationship between the stroke of the piston part and the impact acceleration when the rate of taper on the inner surface of the cylinder part is 1/100.

FIG. 6 is a graph to indicate the relationship between the stroke of the piston part and the impact acceleration when the rate of taper on the inner surface of the cylinder part is 1/80.

FIG. 7 is a graph to indicate the relationship between the stroke of the piston part and the impact acceleration when the rate of taper on the inner surface of the cylinder part is 1/70.

FIG. 8 is a graph to indicate the relationship between the stroke of the piston part and the impact acceleration when the rate of taper on the inner surface of the cylinder part is 1/60.

FIG. 9 is a graph to indicate the relationship between the stroke of the piston part and the impact acceleration when the rate of taper on the inner surface of the cylinder part is 1/50.

FIG. 10 is a graph to indicate the relationship between the stroke of the piston part and the impact acceleration when the rate of taper on the inner surface of the cylinder part is 1/30.

FIG. 11 is a section view of an example of a traditional shock absorber.

### DESCRIPTION OF SYMBOLS

10 Cylinder part
12 Small screw
14 Ring
16 Hex nut
18 Piston
20 Rod part
22 Piston
22 Piston part
24 Sleeve
26 Accumulator
28 O-ring
30 Rod packing
32 Plug
34 Enclosed space
36 Spring

### BEST MODE FOR CARRYING OUT THE INVENTION

The purpose of minimizing the impact acceleration during a collision as much as possible can be achieved by limiting the rate of taper on the inner surface of the cylinder part to the range between 1/50 and 1/130.

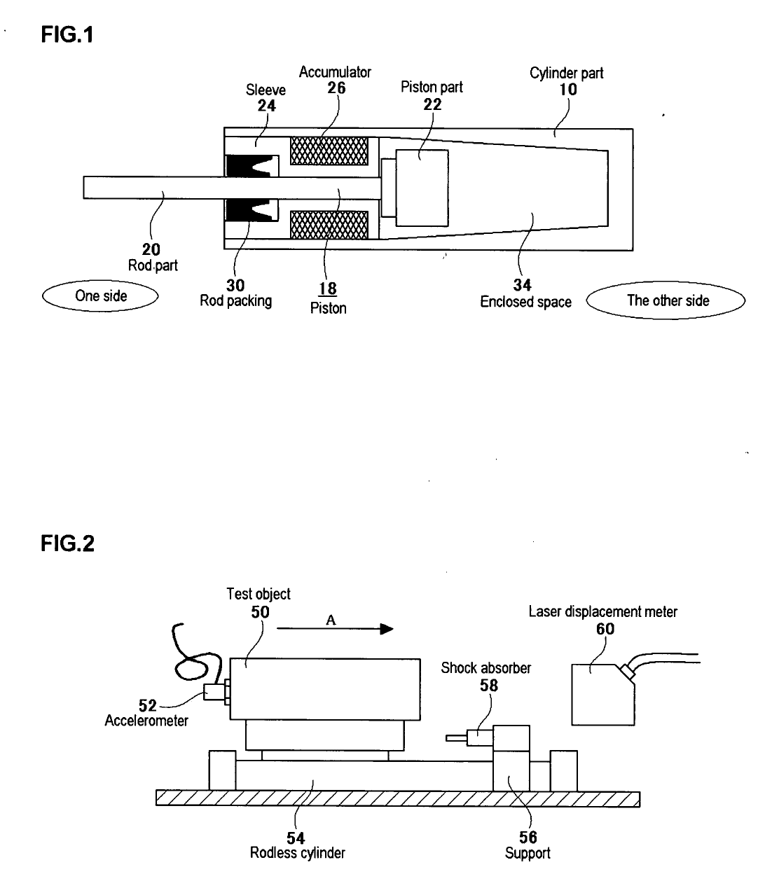

FIG. 1 is an illustration of the shock absorber according to an embodiment of the present invention. Although the basic configuration of the shock absorber in this drawing is generally the same as the one described in BACKGROUND ART, details are omitted for convenience of explanation.

In FIG. 1, a tubular cylinder part is indicated by 10, and the cylinder part 10 has an opening at one end and is closed at the other end. A piston 18 is concentrically inserted into the cylinder part 10 from one end. A piston 18 is composed of a rod part 20 and a piston part 22 which is configured at the end of the rod part 20.

The rod part 20 is surrounded by a sleeve 24 at the part proximal to the piston part 22, and the part distal to the piston part 22 projects from the one end of the cylinder part 10. Outside the sleeve 24, that is, between the sleeve 24 and the cylinder part 10, an accumulator 26 is inserted. Inside the sleeve 24, that is, between the sleeve 24 and the rod part 20, a rod packing 30 is inserted.

Regarding the space inside the cylinder part 10, the area in front of the seal part composed of the sleeve 24, the accumulator 26, and the rod packing 30 is the enclosed space 34. The enclosed space 34 is filled with silicon oil.

The inner surface of the cylinder part 10 inside this enclosed space 34 is tapered reducing its internal diameter from the one end to the other end. The preferred rate of this taper is within the range from 1/50 to 1/130.

The gap between the cylinder part 10 and the piston part 22 is within the range from 1/100 to 5/100 mm. The fluid viscosity of the oil is within the range from 32 to 300 cSt. In addition, the enclosed space of the cylinder part may have the same range of the internal diameter as that of the side of the other end.

Next, the principle of operation of the impact absorption by this shock absorber is described.

The above described shock absorber can be installed so that the end of the rod part 20 can hit the table on which a component is carried, at a point immediately before a predetermined position where that particular carrying table is to be stopped.

When the end of the rod part 20 hits the table, the rod part 20 is forced into the cylinder part 10, and the piston part 22 is pushed to the other side of the cylinder part 10. Thus the fluid is pushed by the piston part 22, and the fluid flows back through the gap between the piston part 22 and the cylinder part 10 while the flow resistance of the fluid absorbs the kinetic energy of the rod part 20, thus reducing the pushing force of the rod part 20 so that the rod part 20 and the table can be stopped at a desired position.

### EXAMPLE

An experimental device as shown in FIG. 2 was prepared. Here, a 2.0 kg block shaped test object is indicated by 50, and an accelerometer 52 is placed at the back of the test object 50. The test object 50 together with the accelerometer 52 is mounted on a rodless cylinder 54 and can be horizontally transferred to the direction indicated by an arrow. A shock absorber 58 supported by a support 56 is placed right in front of the carrying direction of the test object 50. A laser displacement meter 60 is also placed right in front of the test object 50 towards the carrying direction allowing to measure the traveling speed of the test object 50.

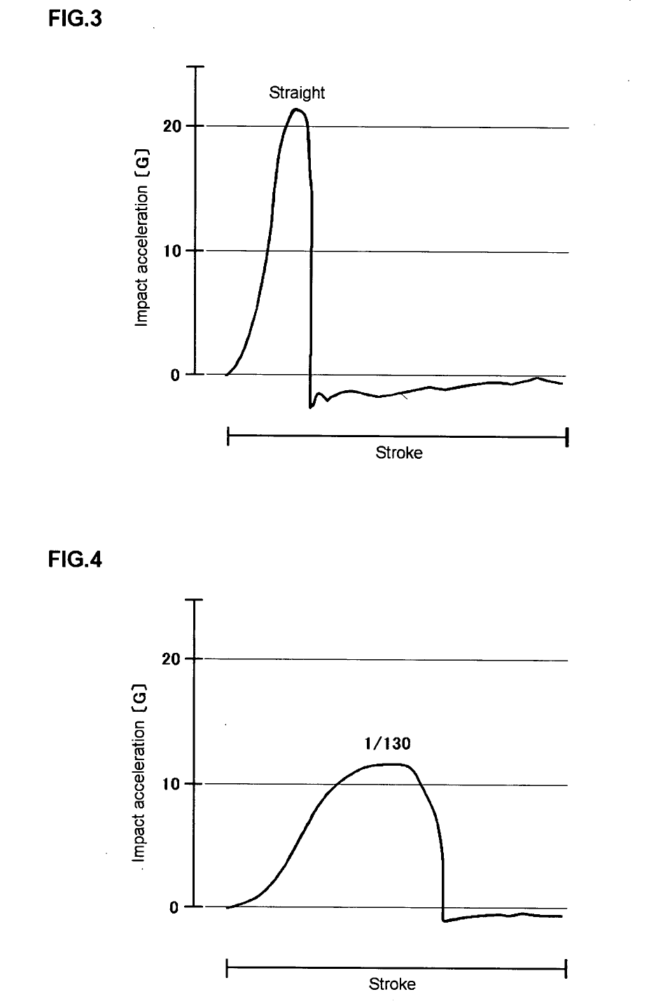

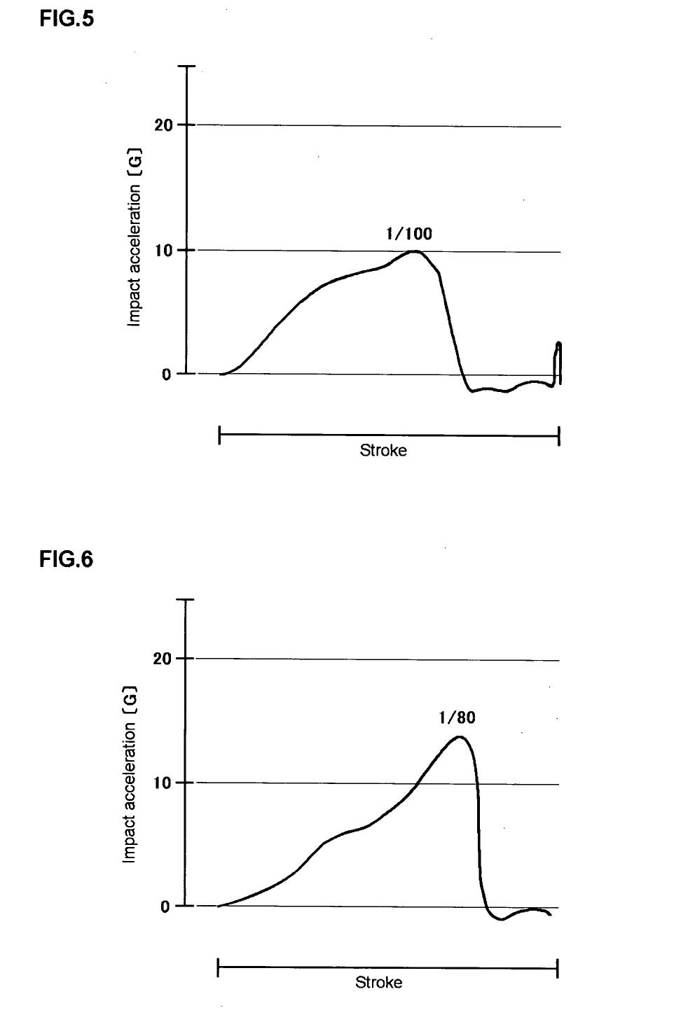

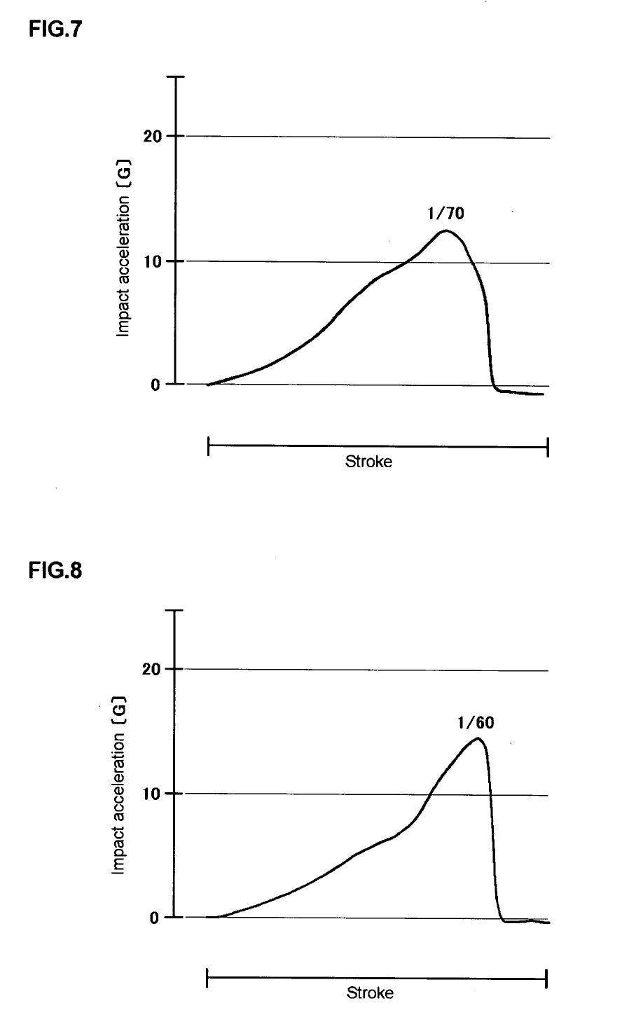

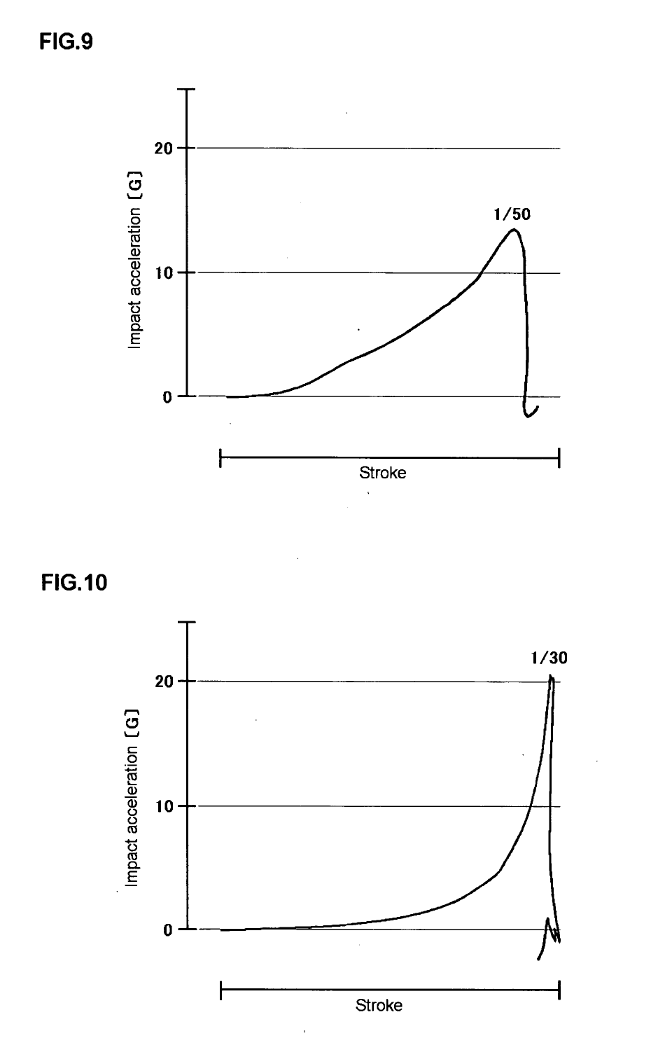

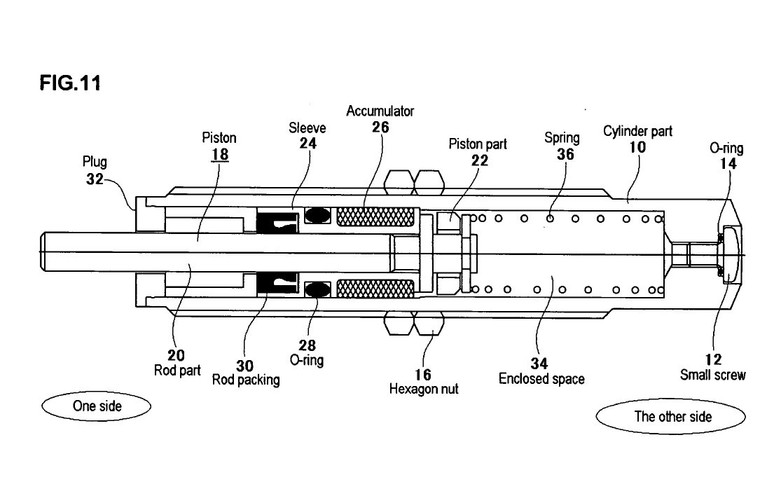

This experimental device was used to transfer the test object 50 in the direction indicated by arrow A with the air pressure inside the cylinder of the rodless cylinder 54 of 0.5 MPa, and the test object was collided at the speed of 1.0 m/s into a shock absorber with various rates of taper ranging from straight to 1/30 on the inner surface of the enclosed space of the cylinder part 10 to obtain each impact acceleration. The results are shown in FIGS. 3 to 10, and the peak values of the impact acceleration are shown in TABLE 1.

TABLE 1

| | Peak value of the impact |
|---|---|
| Rate of taper | acceleration (G) |
| 0 | 22.5 |
| 1/130 | 11.1 |
| 1/100 | 10.2 |
| 1/80 | 14.4 |
| 1/70 | 13.3 |
| 1/60 | 15.0 |
| 1/50 | 14.1 |
| 1/30 | 20.9 |

According to this experiment, if the rate of taper exceeds 1/50, it results in an inconvenience of causing a large impact acceleration by a collision of the piston part 22 into the other end of the cylinder part 10 at the end of the impact absorption after the collision into the shock absorber 58. If the rate of taper is less than 1/130, it results in an inconvenience of causing a large impact acceleration at the beginning of the impact absorption. However, if the rate of taper is between 1/50 and 1/130, it will not result in such inconveniences, thus lowering the peak value of the impact acceleration during a collision.

1. A shock absorber comprising: a tubular cylinder part with an opening at one end and the other end closed; a seal part configured to seal an internal space of said cylinder part at a part closer to said one end inside said cylinder part; fluid filled in an enclosed space formed by said seal part inside said cylinder part; a piston part configured to be slidable inside said enclosed space; and a rod part that slidably penetrates said seal part concentrically and is connected to said piston part at one end while projecting out to the other side, wherein the shock absorber has a tapered inner surface of said cylinder part inside said enclosed space reducing its internal diameter from said one end to said other end, and the rate of this taper is within the range from 1/50 to 1/130.

2. The shock absorber as claimed in claim 1, wherein a gap between said cylinder part and said piston part is within the range from 1/100 to 5/100 mm in proximity to said other end of said cylinder part.

3. The shock absorber as claimed in claim 1, wherein said enclosed space of said cylinder part has the same range of the internal diameter as that of the side of said other end.

4. The shock absorber as claimed in claim 2, wherein said enclosed space of said cylinder part has the same range of the internal diameter as that of the side of said other end.
